(19) United States
(12) Patent Application Publication
(10) Pub. No.: US 2006/0227501 A1
(43) Pub. Date: Oct. 12, 2006

(54) Portable device for CD-ROM drive

(75) Inventor: Casper Lin, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Cremax Tech. Co., Ltd.

(21) Appl. No.: 11/281,741

(22) Filed: Nov. 18, 2005

(30) Foreign Application Priority Data
Apr. 7, 2005 (TW) 094205365

(51) Int. Cl. G06F 1/16

(52) U.S. Cl. 361/685

(57) ABSTRACT

The present invention is a portable device for a CD-ROM drive, which changes a built-in CD-ROM drive to be a portable device. The present invention adopts a replacement frame with the width the same as a 5.25-inch CD-ROM drive and a portable board to fasten the CD-ROM drive. In this way the CD-ROM drive is easily fastened, installed and drawn.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The present invention is a portable device for a CD-ROM drive, which changes a built-in CD-ROM drive to be a portable device. The present invention adopts a replacement frame with the width the same as a 5.25-inch CD-ROM drive and a portable board to fasten the CD-ROM drive. In this way the CD-ROM drive can be easily fastened, installed and detached.

### BACKGROUND OF THE INVENTION

Recently, computer technology has developed so promptly that computer systems are widely applied, digitalizing our lives. Accordingly, the demand for processing data like films, music, photographs, games, and etc. is increased. The CD-ROM has also become one of the most popular media for storing and exchanging data because it has low cost, great storage capacity, is light-weight, and can be carried easily.

Data in CD-ROMs are written via CD-ROM drives that are common to individuals, families and commercial groups. However, the shelf life of a pick-up head in a CD-ROM drive is limited to operate for around 2000 pieces. It is thus necessary for those who use CD-ROM drives frequently, such as one working in digital photo studios, specialists for duplicating CD-ROMs or media workers, to maintain the CD-ROM drives every about 3 to 6 months.

A conventional CD-ROM drive is built in an equipment case. When the CD-ROM drive is broken, the drive needs to be disassembled from the equipment case or the whole equipment needs to be sent for repair, which costs time and money. Therefore, one primary object of the invention is to provide a CD-ROM drive that is installed and maintained easily.

In one embodiment of the invention, a portable device for a CD-ROM drive is applied to a half-height CD-ROM drive or a thin CD-ROM drive is installed into a notch of an external CD-ROM drive, a computer case or a digital processor. Practically, screwing holes of the CD-ROM drive are located on certain positions. A plurality of predetermined notches and screwing holes are reserved on the external CD-ROM drive, the computer case or the digital processor based on the size of the CD-ROM drive. Since the portable device of the invention is thin, the CD-ROM drive and the portable device are fastened onto the case of the external CD-ROM drive, the computer case or the digital processor by adjusting the vertical positions of the screwing holes according to the height of the portable device. The proportion of the CD-ROM drive and the portable device to the external CD-ROM drive, the computer case or the digital processor is “N-1”, wherein N represents the number of predetermined notches. For example, a set of CD-ROM drive is installed in two predetermined notches, and two sets of CD-ROM drives are installed in three predetermined notches.

By means of the portable device of the invention, a CD-ROM drive can be installed into a notch of an external CD-ROM drive, a computer case or a digital processor directly. Hence, the CD-ROM drive is fastened, installed and withdrawn easily, so as to maintain the same conveniently.

One feature of the invention is to change a fixed CD-ROM drive into a portable CD-ROM drive through a portable device. The portable device includes a replacement frame having a width the same as a compartment for fastening a 5.25-inch CD-ROM drive or a portable hard disk. Additionally, the replacement frame is installed in a notch of an external CD-ROM drive, a computer case or a digital processor. A portable board is further used to fasten the CD-ROM drive such that the CD-ROM drive can be withdrawn randomly.

### SUMMARY OF THE INVENTION

The present invention is a portable device for a CD-ROM drive, which is generally applied to a half-high type and slim 5.25-inch CD-ROM drive, and installed in a storing slot of an external CD-ROM drive, a computer case or a digital processor. Practically, a plurality of screwing holes are located on certain locations, such as a plurality of predetermined notches and screwing holes on the external CD-ROM drive, the computer case or the digital processor case, and the predetermined notches and screwing holes being respective to the figures and the dimensions of the external CD-ROM drive, the computer case or the digital processor case. Due to the volume of the present invention is small, to vertically adjust the positions of the screwing holes after comparing with the height of the portable device of the present invention, the portable device for a CD-ROM drive can then be installed in a storing slot of an external CD-ROM drive, a computer case or a digital processor by way of N-1 arrangement. Wherein the N-1arrangement may be defined as N is equal to the number of slots and is greater than 1, which means the arrangement includes N pieces of slots and N-1 pieces of CD-ROM drives, such as one of two slots holding one CD-ROM drive, two of three slots holding two CD-ROM drives, etc.

Therefore, the primary objective of the present invention is to provide the portable device to directly install the “computer CD-ROM drive” in a storing slot of an external CD-ROM drive, a computer case or a digital processor for portable usage, and the “computer CD-ROM drive” is thus mounted, installed and drawn very easily for maintenance and management.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an exploded 3-D sketch of a portable device for a CD-ROM drive of the present invention;

FIG. 2 is an exploded 3-D sketch of a CD-ROM drive and a portable board of the present invention;

FIG. 3 is an assembling sketch of an assembly of the CD-ROM drive, the portable board and the replacement frame of the present invention;

FIG. 4 is a partially magnified 3-D sketch of FIG. 1 of the present invention;

FIG. 5 is a 3-D sketch of a preferred embodiment of the present invention;

FIG. 6 is a 3-D sketch of another preferred embodiment of the present invention.

### DETAILED DESCRIPTION OF THE PREFERRED EMBODIMENTS

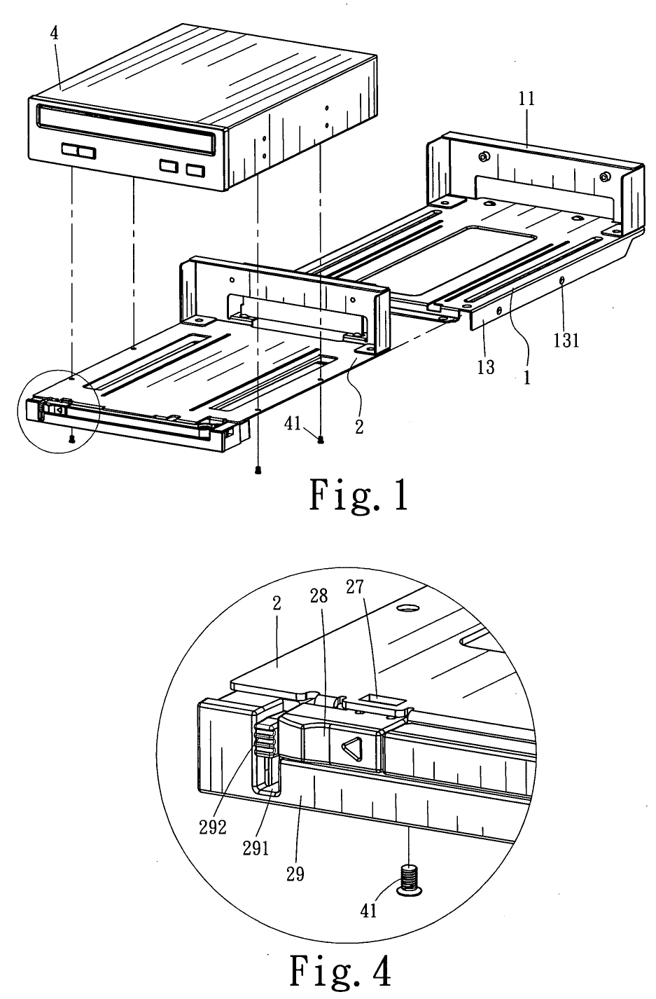

Please refer to FIG. 1, a portable device for a CD-ROM device, the present invention comprises a replacement frame 1 and a portable board 2, the replacement frame 1 has a tail end with a back plate 11, the back plate 11 has a connecting plate 12, the connecting plate 12 has a connecting terminal 12 1, two sides of the replacement frame 1 are installed with relatively two end plates 13, the two end plates 13 have a plurality of screwing holes 131 comparative to the storing slot 3 of the external CD-ROM drive, the computer case or the digital processor.

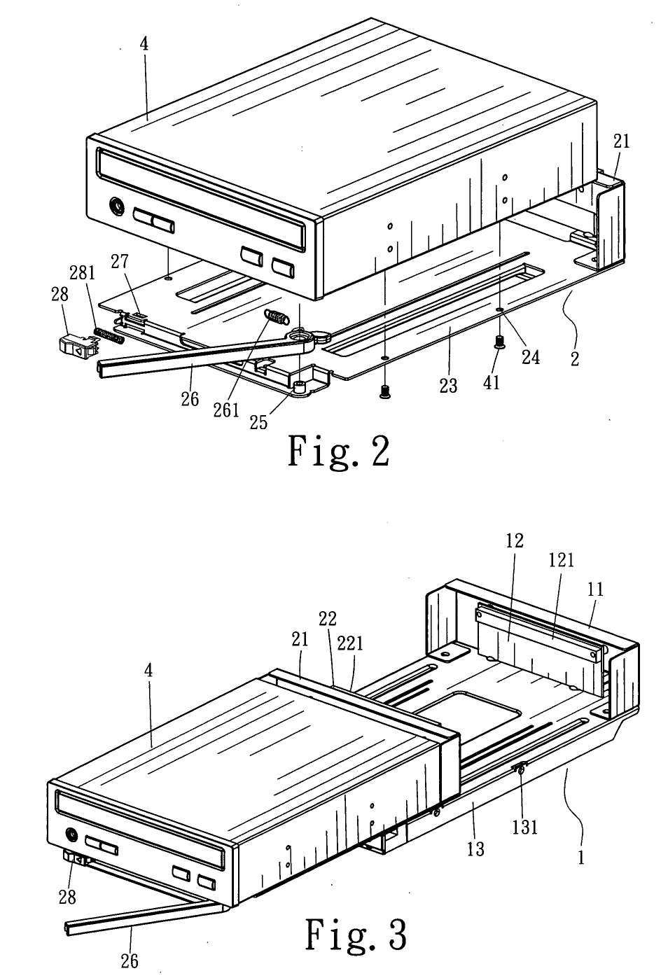

Please refer to FIG. 2, a tail end of the portable board 2 has a back plate 21, the back plate 21 has a connecting plate 22, the connecting plate 22 has a connecting terminal 221, a bearing board 23 of the portable board 2 has a plurality of screwing holes 24 comparative to a plurality of screwing holes on a bottom of the CD-ROM drive 4, a front edge of the bearing board 23 has an axis 25, the axis 25 positions a rotating handle 26, the rotating handle 26 connects a spring 261, a side of a front of the bearing board 23 has a set of buckling holes 27, the set of buckling holes 27 is provided to hook up a buckle-push block 28 connecting a spring 281, the buckle-push block 28 is moved back and forth or blocked, or the rotating handle 26 is released.

Please refer to FIG. 4, the bearing board 23 of the portable board 2 has a cover plate 29 relative to a place below the rotating handle 26, another place beyond the cover plate 29 is set a fillister 291, a buckling block 292 is contained in the fillister 291 and moves up and down to release or block the rotating handle 26.

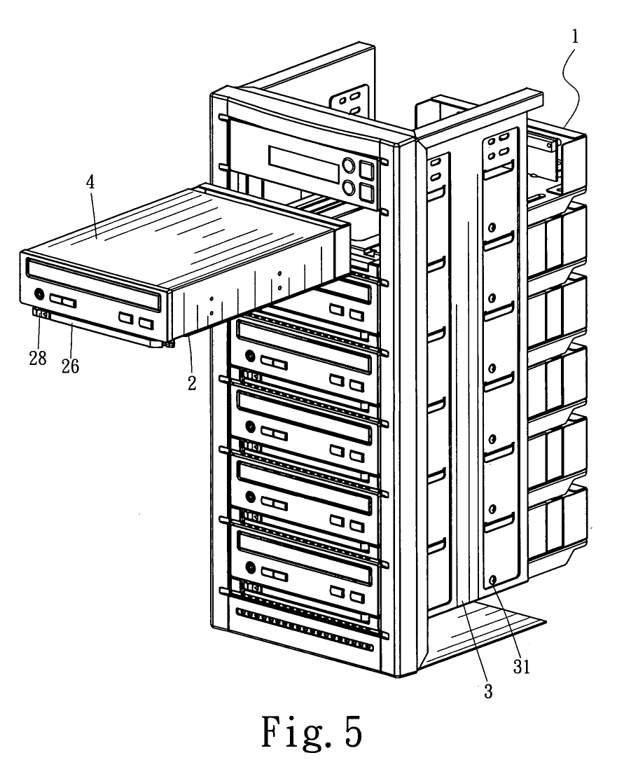

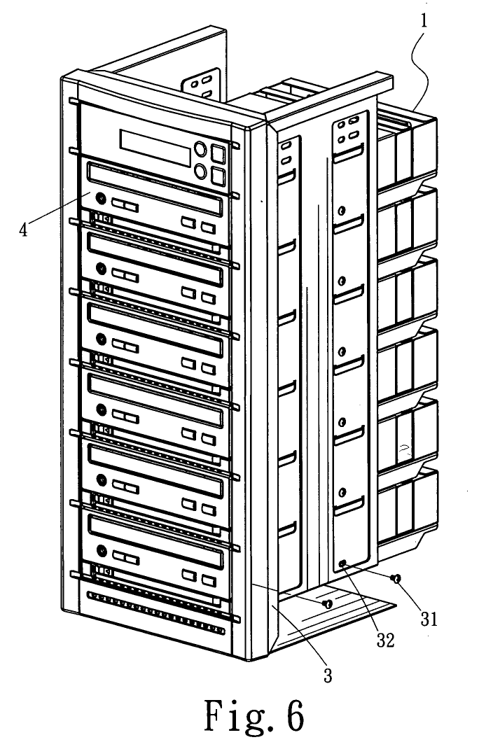

Please refer to FIG. 5 and FIG. 6, a plurality of bolts 31 penetrate through a plurality of screwing holes 32 and the plurality of screwing holes 131 of the two end plates 13 aside to mounted the replacement frame 1 on the storing slot 3 of the external CD-ROM drive, the computer case or the digital processor.

Please refer to FIG. 2, the CD-ROM drive 4 is fixed on the portable board 2 by way of penetrating a plurality of bolts 41 through the plurality of screwing holes 24 of the bearing board 23, the portable board 2 with the CD-ROM drive 4 is capable of sliding into the replacement frame 1 or drawing out. Further, the portable board 2 with the CD-ROM drive.

4 being inserted in or withdrawn out may depend on that the buckling block 292 and the buckle-push block 28 controlling the rotating handle 26.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable device for a CD-ROM drive being installed in a storing slot 3 of an external CD-ROM drive, a computer case or a digital processor by way of N-1 arrangement and comprising:
a replacement frame 1 having a tail end with a back plate 11, the back plate 11 having a connecting plate 12, the connecting plate 12 having a connecting terminal 121, two sides of the replacement frame I being installed relatively two end plates 13, the two end plates 13 having a plurality of screwing holes 131 comparative to the storing slot 3 of the external CD-ROM drive, the computer case or the digital processor, the replacement frame 1 being mounted on the storing slot 3 of the external CD-ROM drive, the computer case or the digital processor;
a portable board 2, a tail end of the portable board 2 having a back plate 21, the back plate 21 having a connecting plate 22, the connecting plate 22 having a connecting terminal 221, a bearing board 23 of the portable board 2 having a plurality of screwing holes 24 comparative to a plurality of screwing holes on a bottom of the CD-ROM drive 4, the CD-ROM drive 4 being fixed on the portable board 2 by way of penetrating a plurality of bolts 41 through the plurality of screwing holes 24 of the bearing board 23, the portable board 2 with the CD-ROM drive 4 being capable of sliding into the replacement frame 1 or being drawn out;
wherein the N-1 arrangement may be defined as N is equal to a number of slots and is greater than 1, which means the arrangement includes N pieces of slots and N-1 pieces of CD-ROM drives.

2. The device of claim 1, wherein a front edge of the bearing board 23 has an axis 25, the axis 25 positions a rotating handle 26, the rotating handle 26 connects a spring 261, a side of a front of the bearing board 23 has a set of buckling holes 27, the set of buckling holes 27 is provided to hook up a buckle-push block 28 connecting a spring 281, the buckle-push block 28 is moved back and forth or blocked, or the rotating handle 26 is released.

3. The device of claim 2, wherein the bearing board 23 has a cover plate 29 relative to a place below the rotating handle 26, another place beyond the cover plate 29 is set a fillister 291, a buckling block 292 is contained in the fillister 291 and moves up and down to release or block the rotating handle 26.

4. The device of claim 1, wherein inserting or withdrawing the portable board 2 with the CD-ROM drive 4 is performed through operation of the rotating handle 26 controlled by the buckling block 292 and the buckle-push block 28.
